(19) United States
(12) Patent Application Publication
(10) Pub. No.: US 2023/0054847 A1
(43) Pub. Date: Feb. 23, 2023

(54) Part Identification and Location Systems and Methods

(71) Applicant: J2B Holdings, LLC, Flowood, MS (US)

(72) Inventors: Joseph Yancy Brock, Flora, MS (US); Joshua Curtis Brock, Madison, MS (US); Ben Austin Hubbard, Brandon, MS (US)

(73) Assignee: J2B Holdings, LLC, Flowood, MS (US)

(21) Appl. No.: 17/404,368

(22) Filed: Aug. 17, 2021

(51) Int. Cl. G06K 9/20; G06K 9/22; G06Q 30/06

(52) U.S. Cl. CPC G06K 9/2054; G06K 9/22; G06Q 30/0603; G06Q 30/0617; G06K 2209/01

(57) ABSTRACT

The present disclosure is a part identification and location system that has a server and a handheld device, and the handheld device is communicatively coupled to the server via a network. Further, the system has a handheld device processor that displays a plurality of graphical user interfaces to the handheld device and receives data from a user of the handheld device identifying a system, subsystem, or part that the user desires to purchase. Additionally, a server processor searches for the desired system, subsystem, or part on a plurality of part databases, locating one or more parts that match the system, subsystem, or part the user desires. The handheld device processor displays a list of the system, subsystems or parts located, receives data indicating which system, subsystem, or part the user desires to purchase, and receives payment data for purchasing the system, subsystem, or part.

### BACKGROUND

An automobile has a myriad of components that make up an operable vehicle. Parts may include an engine, fuel system, exhaust system, cooling system, lubrication system, electrical system, transmission, chassis, front and rear axle, steering system suspension system, wheels, tires, and brakes. These are merely exemplary parts and systems of an operable vehicle. There are other systems, subsystems, and parts not mentioned that are in an operable vehicle.

Oftentimes vehicles are inoperable because one of the systems, subsystems, and parts are not performing their stated function. For example, a transmission may not engage or stay in gear. The transmission may delay shifting or miss gears, the transmission may slip, transmission fluid may be leaking. There are several reasons why a vehicle may not be operating properly or may not be operating at all.

To repair the vehicle, the vehicle may be taken to a repair shop. At the repair shop, the repairmen typically diagnose the problem first. Upon diagnosis, the repairman creates a list of parts needed for the repair of the vehicle. The repairman then calls multiple vendors shopping for the needed components or parts based upon availability, speed of delivery, and price.

The vendors, often resellers, call or source the components or parts needed for the repair and provided by the repairman in the same manner as the repairman. This process is tedious and time-consuming.

### DESCRIPTION OF THE DRAWINGS

The present disclosure can be better understood referencing the following drawings. The elements of the drawings are not necessarily to scale relative to each other, emphasis instead being placed upon clearly illustrating the principles of the present disclosure. Furthermore, like reference numerals designate corresponding parts throughout the several views.

FIG. 1 is a diagram of an exemplary part identification and location system in accordance with an embodiment of the present disclosure.

FIG. 2 is a system block diagram of an exemplary server such as is shown in FIG. 1.

FIG. 3 is a system block diagram of an exemplary handheld device such as is shown in FIG. 1.

FIG. 4 is the exemplary handheld device such as is shown in FIG. 1 and further displaying an exemplary graphical user interface (GUI) having an icon for selecting to execute the part identification and location system such as is shown in FIG. 1.

FIG. 5A is the exemplary handheld device such as is shown in FIG. 1 and further displaying a GUI that is an exemplary Engage Camera GUI of the part identification and location system such as is shown in FIG. 1.

FIG. 5B is the exemplary handheld device such as is shown in FIG. 1 further displaying a GUI that is an exemplary Engage Camera showing a vehicle identification number (VIN) selected for searching on systems, subsystems, or parts of the part identification and location system such as is shown in FIG. 1.

FIG. 6 is the exemplary handheld device such as is shown in FIG. 1 and further displaying an exemplary VIN list GUI listing VIN searches performed recently so that a user may select on a previous VIN search of the part identification and location system such as is shown in FIG. 1.

FIG. 7A is the exemplary handheld device such as is shown in FIG. 1 and further displaying an exemplary Read Vin GUI of the part identification and location system such as is shown in FIG. 1.

FIG. 7B is the exemplary handheld device such as is shown in FIG. 1 and further displaying a GUI that is an exemplary Read Universally Unique identifier GUI of the part identification and location system such as is shown in FIG. 1.

FIG. 7C is the exemplary handheld device such as is shown in FIG. 1 and further displaying a GUI that is an exemplary Read Vehicle GUI of the part identification and location system such as is shown in FIG. 1.

FIG. 7D is the exemplary handheld device such as is shown in FIG. 1 and further displaying a GUI that is an exemplary Read Part GUI of the part identification and location system such as is shown in FIG. 1.

FIG. 8 is the exemplary handheld device such as is shown in FIG. 1 and further displaying an exemplary Vehicle Information GUI that comprises data about a vehicle returned related to the data entered in FIG. 7A-7B of the part identification and location system such as is shown in FIG. 1.

FIG. 9 is the exemplary handheld device such as is shown in FIG. 1 and further displaying a Select Search Category GUI of the part identification and location system such as is shown in FIG. 1.

FIG. 10 is the exemplary handheld device such as is shown in FIG. 1 and further displaying a Configurations of the part identification and location system such as is shown in FIG. 1.

FIG. 11 is the exemplary handheld device such as is shown in FIG. 1 and further displaying an exemplary Categories GUI of the part identification and location system such as is shown in FIG. 1.

FIG. 12 is the exemplary handheld device such as is shown in FIG. 1 and further displaying an exemplary Part Selection of the part identification and location system such as is shown in FIG. 1.

FIG. 13 is the exemplary handheld device such as is shown in FIG. 1 and further displaying a Purchase Part GUI of the part identification and location system such as is shown in FIG. 1.

FIG. 14 is the exemplary handheld device such as is shown in FIG. 1 and further displaying a Checkout GUI of the part identification and location system such as is shown in FIG. 1.

FIG. 15 is a flowchart describing exemplary architecture and functionality of the part identification and location system such as is shown in FIG. 1.

### DETAILED DESCRIPTION

The present disclosure is an exemplary part identification and location system in accordance with an embodiment of the present disclosure. The part identification and location system of the present disclosure comprises two basic components. That is, the part identification and location system of the present disclosure comprises a handheld device component and a server component that communicates with the handheld device via a network.

In this regard, a user of the handheld device reads a universally unique identifier (UUID) associated with a vehicle. For example, if the user desires to purchase parts for an automobile, the user reads the Vehicle Identification Number (VIN) using a camera contained in the handheld device and identifies a part, system, or subsystem for which a part(s) is needed in an improvement, enhancement, repair or otherwise. Through computer vision and optical character recognition (OCR) by the handheld device and the server, the UUID is read and recognized.

Note that hereinabove describes locating a part using a read of a VIN of a vehicle. The handheld device may further read a Universally Unique Identifier (UUID), an image of a vehicle, an image of a part, etc., to identify and locate a needed part for repair, enhancement or otherwise.

Upon receipt of the VIN, the UUID, the image of the car, or the image of the part, the server correlates the data with the correct associated part(s) required for the improvement, enhancement, and repair. The identification of the VIN, UUID, image of the car or image of the part may be performed using computer vision with artificial intelligence and OCR on the handheld device and/or the server.

The server then sources the associated parts across different categories and geo-spatial location to identify an estimate delivery date to the user's address/location. The server searches a plurality of part databases (representing different vendors). Note that in one embodiment, the user captures digital images of a part or the vehicle, which allows the server to utilize computer vision and machine learning to identify the part or vehicle to search for parts or vehicles directly based on characteristics of the parts or vehicle.

Initially, for the UUID or VIN, the part identification and location system performs OCR on an image read by the handheld device and/or the server. Then, the handheld device and/or the server performs computer vision on the data read. Computer vision refers to the ability to see, read and recognize specific objects or data within an unstructured format. It falls under the broad area of Artificial Intelligence.

Computer Vision works by digesting massive quantities of data on related images to recognize specific characteristics and patterns, e.g., images of auto parts or vehicles. It extracts information from images/pixels of the images read by the handheld device. Computer Vision identifies those ‘areas’ or ‘regions’ of interest in given data and converts the images into a structured format. Our VIN structure works like the above only we do OCR first and then do some Artificial Intelligence (AI) on the unstructured text via the handheld device and/or the server. Notably, the OCR and computer vision aided with the Artificial Intelligence by be performed by the handheld device and/or the server.

The part databases transmit data to the server indicative of the vehicle, which can include an image of the part, the part number, the cost of the part, the location of the part, how many are in stock, and the fitment data. The fitment data is made up of all the details of auto parts that fit any given vehicle.

The server displays to the user a listing of parts that match the search data, i.e., the VIN, UUID, vehicle, or part. In displaying the parts, the server can display data that indicates when each part will be delivered to the user.

The user selects from the listing one or more of the parts that the user desires to purchase. In this regard, the user can save the part in a digital cart, or the user can buy the part directly.

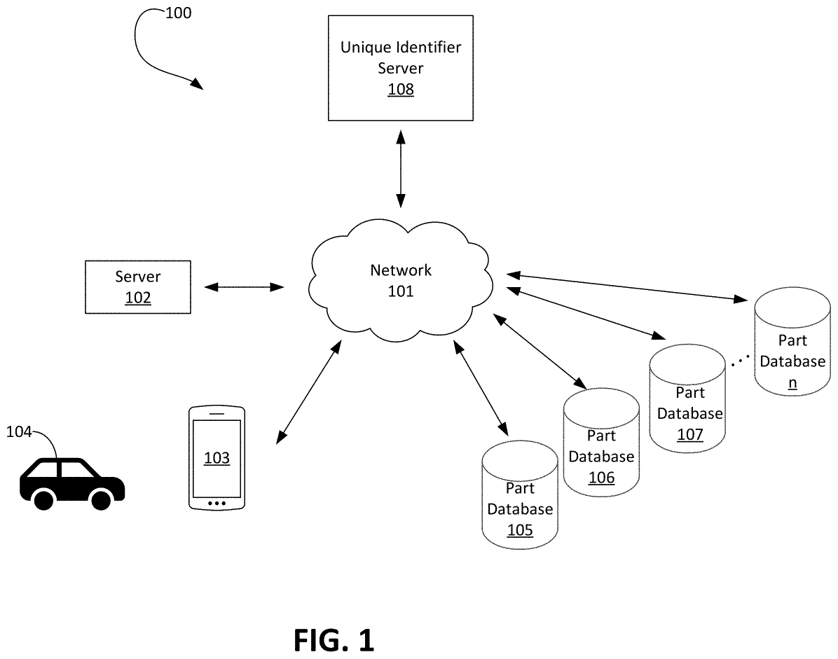

FIG. 1 is an exemplary part identification and location system 100 in accordance with an embodiment of the present disclosure. The part identification and location system 100 comprises a handheld device 103 that communicates with a server 102 over a network 101. Further, the part identification and location system 100 comprises a unique identifier server 108 and a plurality of part databases 105-n, which represent databases of different vendors. The server 102 communicates with the unique identifier server 108 and the plurality of part databases 105-n over the network 101.

In operation, a user (not shown) may use the handheld device 103 to capture image views indicative of a vehicles VIN. Note that the handheld device can further read images of a Universally Unique Identifiers (UUID), vehicle or a part. In this regard, the user places the camera (not shown) over the VIN usually in a window of a vehicle 104 and, the system utilizes optical character recognition (OCR) supported by Computer Vision, as described above, to automatically identify and capture the VIN once it comes into view.

The handheld device 103 transmits the VIN to the server via the network 101. In one embodiment once the server receives the VIN the server 102 transmits the VIN to the unique identifier server 108. Upon receipt, the unique identifier server 108 may obtain from the 17-character VIN (digits and capital letters) where the vehicle 104 was built, the manufacturer, vehicle brand, engine size and type, the model year of the vehicle 104, the plant that assembled the vehicle 104, and a serial number of the vehicle 104. Once the VIN number has been analyzed by the unique identifier server 108, the unique identifier server 108 transmits data indicative of the VIN details to the server 102.

In another embodiment, the server 102 may comprise VIN-analysis algorithm. Thus, the unique identifier server 108 may not be needed. In this regard, the server breaks down the VIN into its representative data. That is, the first character is where the vehicle 104 was built, the 2^{nd} and 3^{rd} characters identify the manufacturer, the 4^{th}-8th characters identify the vehicle brand, engine size and type. The 10^{th} character identifies the model year of the vehicle 104, and the 11^{th} character indicates where the vehicle 104 was assembled. The last six characters identify the serial number of the vehicle 104.

The server 102 displays at least the make, model, year, and engine model to the user via the handheld device 103. The user indicates whether the information is correct.

If the information is correct, the server 102 may display a list of configurations of the vehicle. For example, the vehicle may be a 2013 Lexus RX350 3.5 Liter V6 2GRFE. The different configurations may include F Sport U880F, Base U660E, and Base U660F. The user selects the correct vehicle from the list.

Once the correct vehicle 104 is returned or selected, the server displays 102 the categories of systems, subsystems, or parts to the user via the handheld device 103. For example, categories may be torque converters, overhaul (rebuild kit), master L/steels (rebuild kit), master W/steels (rebuild kit), filters, bushings, metal clad seals, friction plates, steel plates, etc., assuming that the user has selected to receive data indicative and related to transmissions.

The user selects one of the categories. Based on the category selected, the server 102 queries each of the part database 105-n. In response, the part databases 105-n return data indicative of the part desired by the user for the vehicle/category selected. This data may include an image of the part, name of the part, cost of the part, year of the vehicle on which the part is to be installed, a delivery time, and vehicle fitment data. In one embodiment, the server 102 determines the delivery date based upon the geo-location of the user. Note that in one embodiment, the handheld device 103 displays a list of vehicle components prior to displaying the list of categories. For example, the user may select from the list of components belt drive, brake & wheel hub, cooling system, drivetrains, electrical, exhaust & emission, heat and air conditioning, ignition, steering, suspension, transmission, and wheel. After selection of a component, the handheld device 103 displays the list of categories, as described above.

From the list of parts available from the vendors of the part databases 105-n displayed to the user, the user selects which part he/she desires. Data indicative of the part selected may be placed in a digital shopping cart. In addition, the user can buy the part circumventing the digital shopping cart.

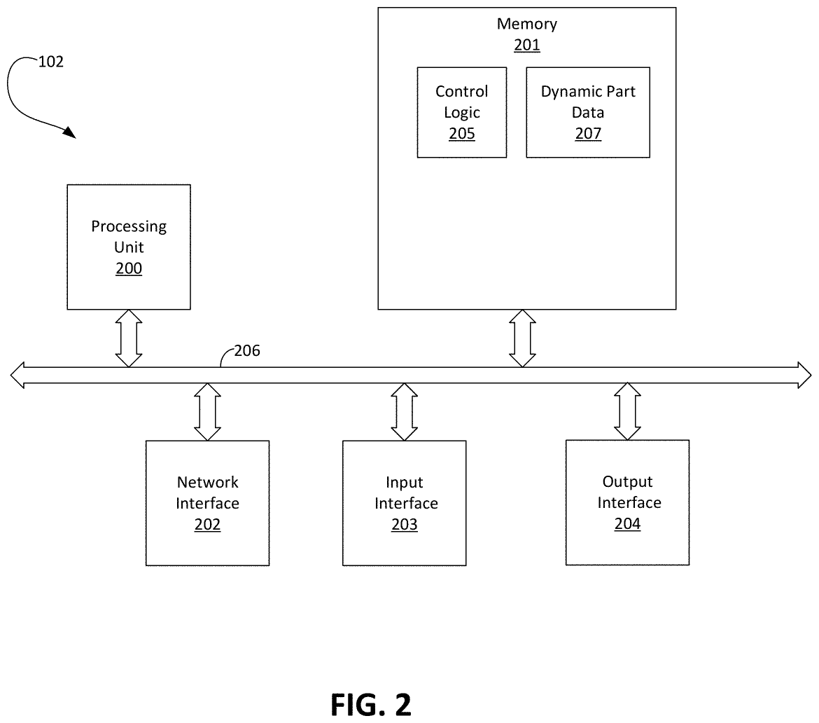

FIG. 2 is a block diagram of an exemplary embodiment of the server 102 depicted in FIG. 1. As shown by FIG. 2, the server 102 comprises a processing unit 200, a network interface 202, an input interface 203, an output interface 203, and memory 261. Stored in memory 261 is control logic 205. The control logic 205 may be software, hardware, firmware, or a combination thereof. Further, the server 102 comprises dynamic part data 207.

The exemplary embodiment of the server 102 depicted by FIG. 2 comprises at least one conventional processing unit 200, such as a Digital Signal Processor (DSP) or a Central Processing Unit (CPU), that communicates to and drives the other elements within the server 102 via a local interface 206, which can include at least one bus. Further, the processing unit 200 is configured to execute instructions of software, such as the control logic 205.

The control logic 205 generally controls the functionality of the server 102, as will be described in more detail hereafter. As noted above, the control logic 206 can be implemented in software, hardware, firmware, or any combination thereof. In an exemplary embodiment illustrated in FIG. 2, the control logic 205 is implemented in software and stored in memory 201.

Note that the control logic 205, when implemented in software, can be stored, and transported on any computer-readable medium for use by or in connection with an instruction execution apparatus that can fetch and execute instructions. In the context of this document, a “computer-readable medium” can be any means that can contain or store a computer program for use by or in connection with an instruction execution apparatus.

The input interface 203, for example, a keyboard, keypad, or mouse, can be used to input data from a support/maintenance user of the server 102, and an output interface 204, for example, a printer or display screen (e.g., a Liquid Crystal Display (LCD)), can be used to output data to the user of the server 102.

In addition, the network interface 202, such as a Network Interface Card (MC), enables the server 102 to communicate via the internet 101 (FIG. 1) with the handheld device 103 and the plurality of part databases 105-n.

The dynamic part data 207 is data indicative of information received from the handheld device 103. Further, the dynamic part data 207 may be data received from the plurality of part databases 105-n.

In operation, the control logic 205 receives data from and transmits data to the handheld device 103. In this regard, the control logic 205 transmits data that is used by the handheld device to populate the plurality of graphical user interfaces (GUIs) (not shown). Furthermore, the control logic 205 transmits vehicle data and system, subsystem, or part data to the parts databases 105-n. In response, the parts databases 105-n transmits data indicative of the system, subsystem, or part to the control logic 205, and the control logic 205 stores the data received as dynamic part data 207, which is thereafter transmitted to the handheld device 103 for display to the user.

In one embodiment, the handheld device 103 and/or the control logic 205 comprise a Computer Vision algorithm based upon Machine Learning techniques such as Pattern and Object Recognition and/or Deep Learning. In this regard, the handheld device 103 and/or the control logic 205 are provided a massive amount of system, subsystem, or part data prior to use of the handheld device 103 and/or the control logic 205 to find systems, subsystems, or parts.

Notably, the handheld device 103 and/or the control logic 205 is trained to receive the massive amount data, process images, label objects on the images, and find patterns and to identify in those the relevant objects in the data.

For example, a million images of parts are sent to the server 102 (FIG. 1). Upon receipt, the handheld device 103 and/or the control logic 205 analyze the images and identifies patterns and/or objects that are like a part. In the end, the handheld device 103 and/or the control logic 205 create a model and learn to identify a parts. As a result, the handheld device 103 and/or the control logic 205 accurately detect whether an image is the part when an image is received by the handheld 103 (FIG. 1) and/or transmitted to the control logic 205.

Thus, in addition to OCR/Computer Vision that recognizes and categorizes characters, the handheld device 103 and the control logic 205 recognize an image of a part or a vehicle. So, when a user of the handheld 103 takes a photograph of a part, the handheld device 103 and/or the control logic 205 recognize the part and the control logic 205 performs a search of the part based upon the image read by the handheld device 103.

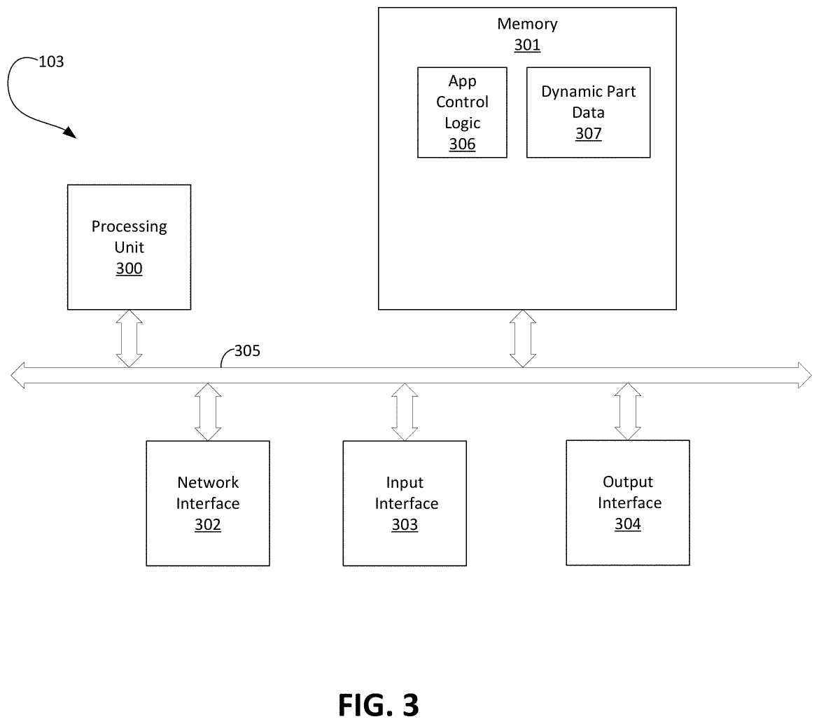

FIG. 3 is a block diagram of an exemplary embodiment of the handheld device 103 depicted in FIG. 1. As shown by FIG. 3, the handheld device 103 comprises at least a processing unit 300, a network interface 302, an input interface 303, an output interface 304, and memory 301. Stored in memory 301 is app control logic 205. The app control logic 205 may be software, hardware, firmware, or a combination thereof. Further, the handheld device 103 comprises dynamic part data 307.

The exemplary embodiment of the handheld device 103 depicted by FIG. 3 comprises at least one conventional processing unit 300, such as a Digital Signal Processor (DSP) or a Central Processing Unit (CPU), that communicates to and drives the other elements within the handheld device 103 via a local interface 305, which can include at least one bus. Further, the processing unit 300 is configured to execute instructions of software, such as the app control logic 306.

The app control logic 306 generally controls the functionality of the handheld device 103, as will be described in more detail hereafter. As noted above, the app control logic 306 can be implemented in software, hardware, firmware, or any combination thereof. In an exemplary embodiment illustrated in FIG. 3, the app control logic 306 is implemented in software and stored in memory 301.

Note that the app control logic 306, when implemented in software, can be stored, and transported on any computer-readable medium for use by or in connection with an instruction execution apparatus that can fetch and execute instructions. In the context of this document, a “computer-readable medium” can be any means that can contain or store a computer program for use by or in connection with an instruction execution apparatus.

The input interface 303, for example, a touch screen or a microphone, can be used to input data from a user of the handheld device 103. In this regard, the user may use the touch screen or provide input to the microphone to select a part from a list displayed by the app control logic 306. Also, the input device 303 may be a camera (not shown) that receives images, e.g., a VIN of a vehicle 104 (FIG. 1).

The output interface 304, for example, a display device (e.g., a Liquid Crystal Display (LCD)), can be used to output data to the user of the handheld device 103. In this regard, the app control logic 306 may display to the user GUIs configured to identify a vehicle, list parts, and receive a selection of a part from the user of the handheld device 103.

In addition, the network interface 202, such as a Network Interface Card (MC), enables the handheld device 103 to communicate via the network 101 (FIG. 1) with the server 102.

The dynamic part data 207 is data indicative of information received from the server 102. The dynamic part data 207 may be any data indicative of selections by the user of the handheld device 103 and data received from the server 102.

In operation, the app control logic 306 reads data of the VIN, UUID, image of a vehicle, or image of a part. In one embodiment, the app control logic 306 and/or the control logic 205 (FIG. 2) comprise a Computer Vision algorithm based upon machine learning techniques such as Pattern and Object Recognition and/or Deep Learning. In this regard, the app control logic 306 is provided a massive amount of system, subsystem, or part data prior to use of the app control logic 306 and/or the control logic 205 to find systems, subsystems, or parts.

Notably, the app control logic 306 and/or the control logic 205 are trained to receive the massive amount data, process images, label objects on the images, and find patterns and to identify the relevant objects (parts or vehicles) in the data.

For example, a million images of parts are sent to the handheld device 103. Upon receipt, the app control logic 306 and/or the control logic 205 analyzes the images and identifies patterns and/or objects that are like a part. In the end, the app control logic 306 and/or the control logic 205 learns to identify parts. As a result, the app control logic 306 and/or the control logic 205 accurately detects whether an image is a VIN, UUID, vehicle, or part when an image is read by the handheld 103.

Thus, in addition to OCR/Computer Vision that recognizes and categorizes characters, the app control logic 306 and the control logic 205 recognize an image of a part or a vehicle and identifies its meaning. So, when a user of the handheld 103 reads a part, the app control logic 306 and/or the control logic 205 recognize the part and perform a search of the part based upon the image read by the handheld device 103.

The handheld device 103 transmits analytics data to the server 102 (FIG. 1). In this regard, the app control logic 306 transmits data read by the handheld device 103 and data resulting from the OCR and computer vision that is used by the control logic 205 to perform searches on part databases 105-n.

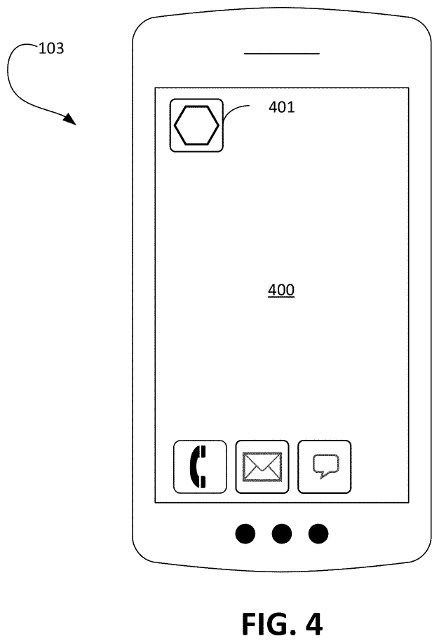

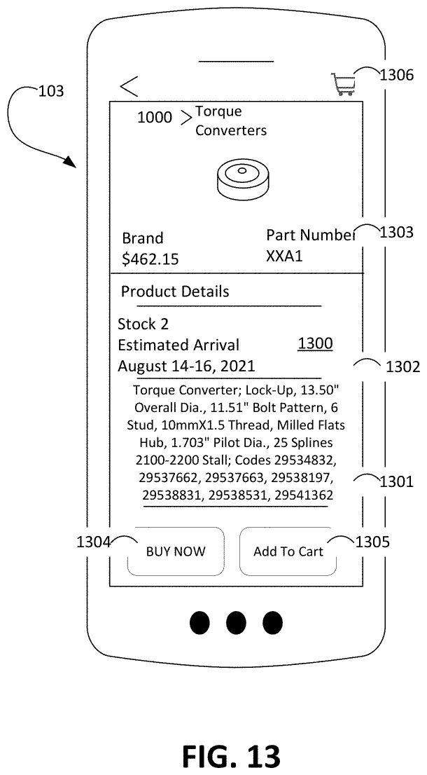

FIGS. 4 through 14 depict the functionality of the part identification and location system 100 (FIG. 1).

FIG. 4 is a handheld device 103 displaying a home GUI 400 of the handheld device 103. Note that the home GUI 400 typically comprises a plurality of icons, but for simplicity only the mobile device app icon 401 is shown. In operation, a user of the handheld device 103 selects the mobile device app icon 401 to begin the process of identifying and locating a part.

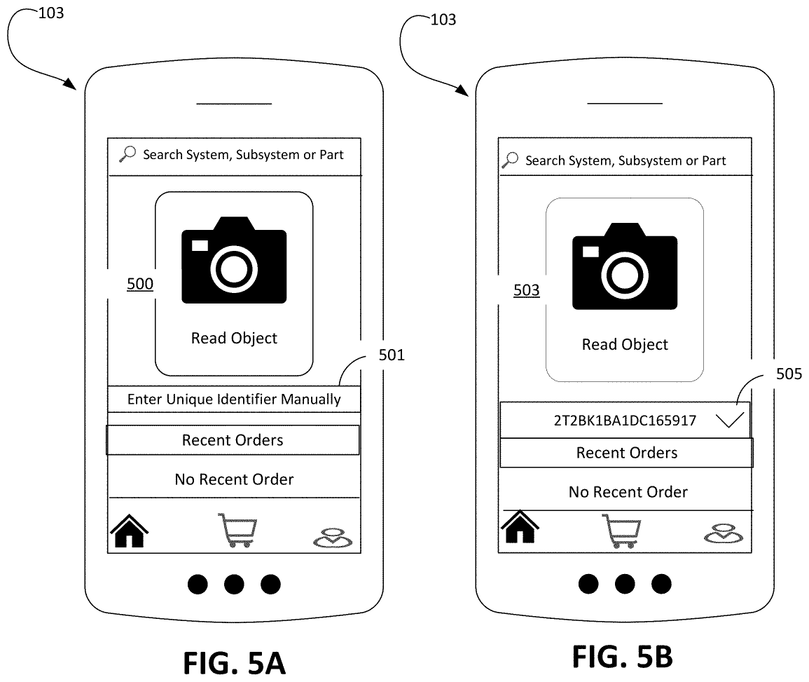

With FIG. 5A is the handheld device 103 displaying a engage camera GUI 500. With reference to FIG. 5A, when the user of the handheld device 103 selects the mobile device app icon 401, the engage camera GUI 500 is displayed. In textbox 501, the user of the handheld device 103 may enter a system, subsystem, or a part number that the user of the handheld device 103 desires to obtain. Also, the user may select the box 501 and read an image of a UUID, VIN, subsystem, system, or part in which the user is interested.

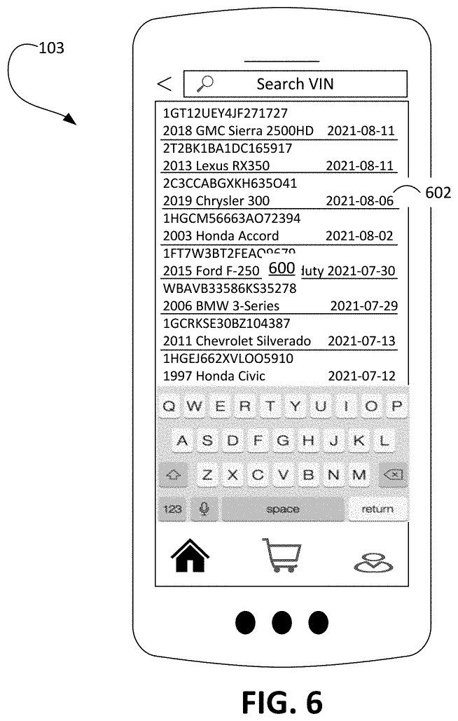

FIG. 5B is the handheld device 103 displaying another engage camera GUI 503 that comprises a pulldown box 505. Displayed in the pulldown box 505 is the VIN read by the handheld device 103. If the user pulls down the box 505, the handheld device 103 displays the GUI 600 depicted in FIG. 6.

FIG. 6 is the handheld device 103 displaying a search list GUI 600. In this regard, GUI 600 comprises a list 602 of VIN numbers representing previous searches. Along with the VIN numbers, the data includes the vehicle data and the date the previous search was performed.

The user may select one of the VIN numbers from the list, and the handheld device 103 will display data indicative of the previous search.

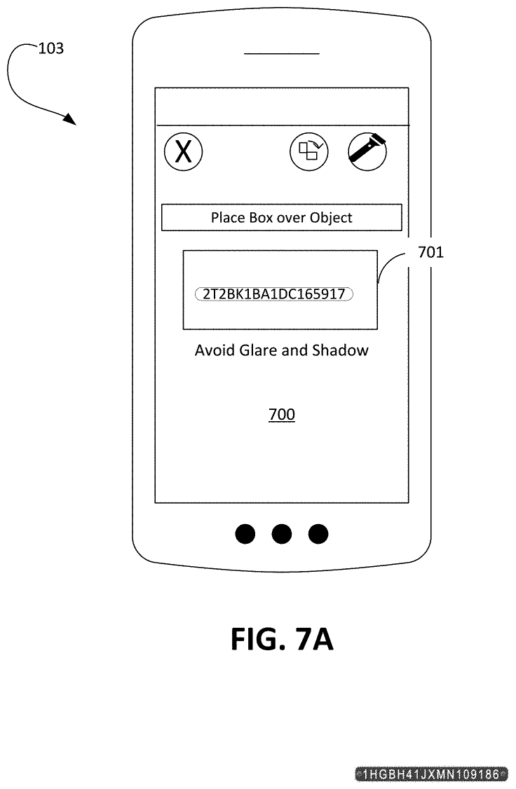

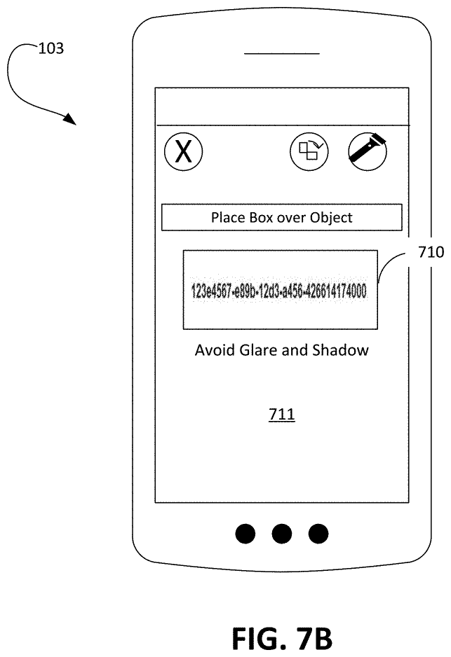

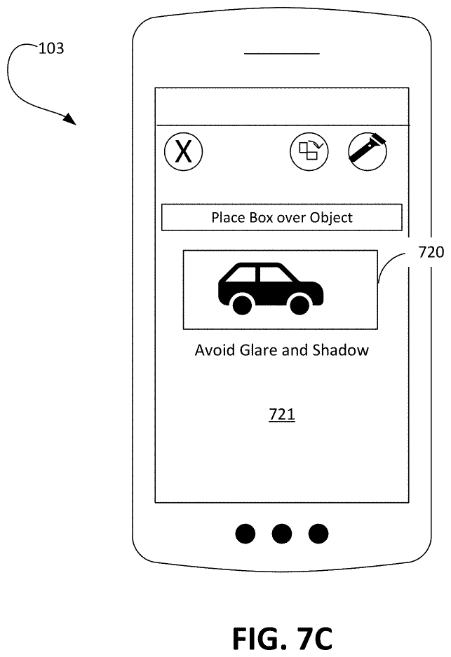

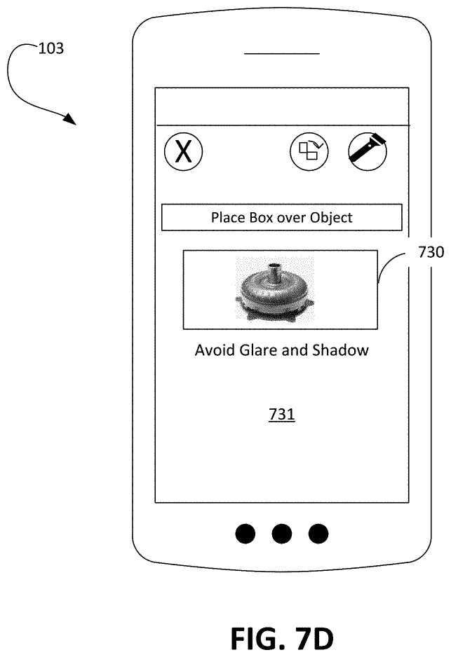

FIG. 7A is the handheld device 103 displaying a read VIN GUI 700 in accordance with an embodiment of the present disclosure. If the user selects to read an image of the VIN of a vehicle, the read image GUI 700 comprises the read image square 701. The user of the handheld device 103 places the read image square 701 over the object that the user of the handheld device 103 wishes to read and the handheld device 103 reads the image. Data indicative of the image is displayed in the read image square 701, e.g., 2T2BK1BA1DC165917, a vehicle's VIN.

The app control logic 306 (FIG. 3) and the control logic 206 (FIG. 2) perform OCR and Computer Vision aided by Artificial Intelligence on the image read. Further, the app control logic 306 and the control logic 205 are configured to perform Computer Vision and Artificial Intelligence to obtain more data about the image read.

In another embodiment, the user may desire to read an image of a UUID, which is shown in FIG. 7B. If the user selects to read an image of the UUID, the read image GUI 711 comprises the read image square 710. The user of the handheld device 103 places the read image square 710 over the object that the user of the handheld device 103 wishes to read and the handheld device 103 reads the image. Data indicative of the image is displayed in the read image square 701, e.g., 123e4567-e89b-12d3-a456-426614174000, a UUID.

The app control logic 306 (FIG. 3) and/or the control logic (FIG. 2) perform OCR on the image read. Further, the app control logic 306 and the control logic 205 are configured to perform Computer Vision and Artificial Intelligence on the image read to obtain more data about the image read.

FIG. 7C is the handheld device 103 displaying a read vehicle GUI 721 in accordance with an embodiment of the present disclosure. If the user selects to read an image of the vehicle, the read image GUI 721 comprises the read image square 720. The user of the handheld device 103 places the read image square 720 over the object that the user of the handheld device 103 wishes to read and the handheld device 103 reads the image. Data indicative of the image is displayed in the read image square 701, e.g., a vehicle.

The app control logic 306 (FIG. 3) and/or the control logic 205 (FIG. 2) perform Computer Vision and Artificial Intelligence to obtain more data about the image read and to identify the vehicle, such as year, make, and model. Further, the app control logic 306 and/or the control logic 205 are configured to perform computer vision and artificial intelligence to obtain more data about the image read.

FIG. 7D is the handheld device 103 displaying a read part GUI 731 in accordance with an embodiment of the present disclosure. If the user selects to read an image of a part, the read image GUI 731 comprises the read image square 730. The user of the handheld device 103 places the read image square 730 over the object that the user of the handheld device 103 wishes to capture and the handheld device 103 reads the image. Data indicative of the image is displayed in the read image square 730, e.g., a part.

The app control logic 306 (FIG. 3) and/or the control logic 205 (FIG. 2) perform Computer Vision and Artificial Intelligence to obtain more data about the image read and to identify the part. Further, the app control logic 306 and/or the control logic 205 are configured to perform Computer Vision and Artificial Intelligence to identify and obtain more data about the image read.

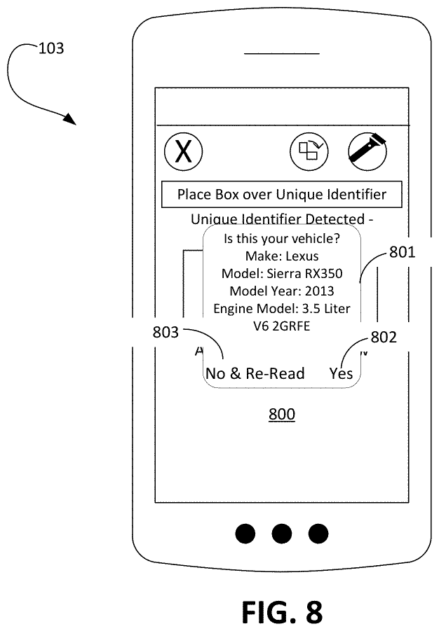

FIG. 8 is the handheld device 103 displaying a vehicle identification GUI 800. If the user reads a VIN, UUID or image, the vehicle identification GUI 800 is displayed to the handheld device 103. In this regard, the vehicle identification GUI 800 provides data about the “Make,” “Model,” “Year,” and “Engine Model” in the popup box 801.

To proceed, the user may select the “No & ReRead” text 803 if the vehicle identification information is correct, and the user can reread the object, i.e., VIN, UUID, vehicle, or part. If the correct vehicle identification information is displayed, the user can select the “Yes” text 802.

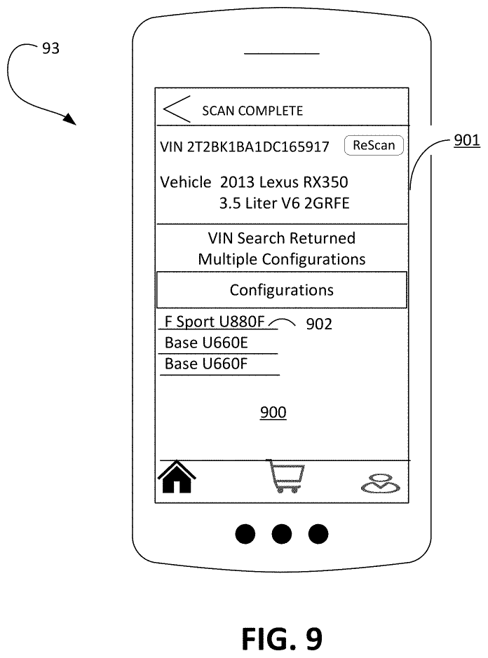

FIG. 9 is the handheld device 103 displaying vehicle configuration options GUI 900. Oftentimes, there may be more than one configuration associated with a VIN, UUID, vehicle image or part image. In such a scenario, the handheld device 103 displays GUI 900 and the different configurations 902, e.g., “F Sport U880F,” “Base U660E,” and “Base U660F” associated with the vehicle, the details of which are displayed in box 901. The user of the handheld device 103 selects which configuration applies to the vehicle 104 (FIG. 1) before a search for parts is performed.

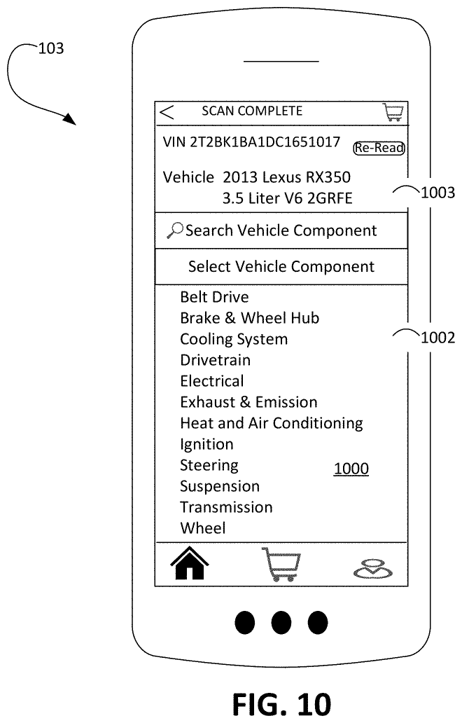

Once the configuration is selected in vehicle configuration GUI 900, the handheld device 103 may display the vehicle component GUI 1000 in FIG. 10. The vehicle component GUI 1000 displays the VIN and the vehicle identification data in box 1003.

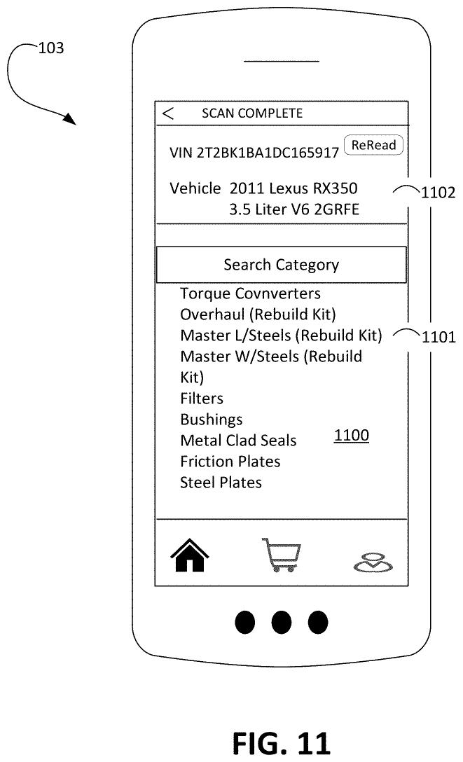

In this regard, the app control logic 306 (FIG. 3) requests the vehicle component data from the server 102 and displays the vehicle component data 1002 to the GUI 1000. The vehicle component data 1002 comprises the systems and subsystems of the vehicle. These include the “Belt Drive,” “Brake & Wheel Hub,” “Cooling System,” “Drivetrain,” “Electrical,” “Exhaust & Emission,” “Heat and Air Conditioning,” Ignition,” “Steering,” “Suspension,” “Transmission,” and ‘Wheel.” The user can select one of the vehicle components by clicking on the descriptive working. For example, if the user desires to view parts associated with the “Heat and Air Conditioning,” the user selects the “Heat and Air Conditioning” descriptor. In the example provided, the user selects the “Transmission” descriptor, and the handheld device 103 display the category GUI 1100 shown in FIG. 11.

Note that the component information 1002 may be transmitted to the handheld device 103 from the server 102. In this regard, the server 102 queries the part databases 105-n, which returns relevant information about the vehicle including the fitment information that includes all the parts available for the vehicle.

The category GUI 1100 in FIG. 11 displays the VIN and the vehicle description in box 1102. Associated with this VIN and vehicle information is a set of categories 1101. The categories include “Torque Converters,” “Overhaul (Rebuild Kit),” Master L/Steels (Rebuild Kit),” Master W/Steels (Rebuild Kit),” “filters,” “Bushings,” “Metal Clad Seals,” “Friction Plates,” and “Steel Plates.”

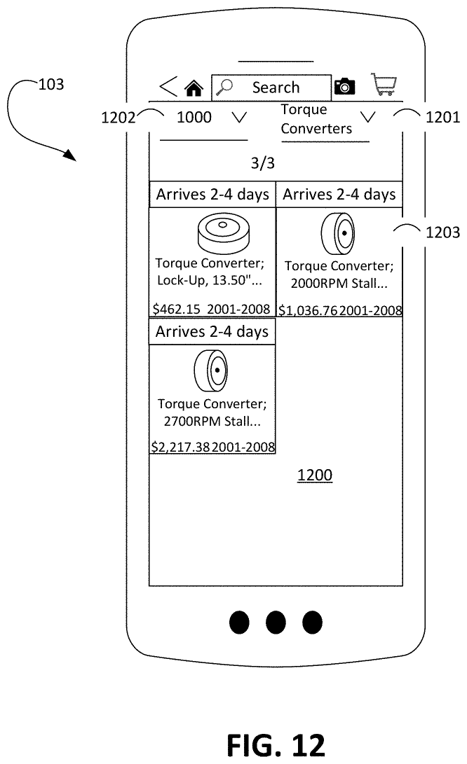

The user can select one of the vehicle categories 1101 by clicking on the descriptive wording. For example, if the user desires to view parts associated with the “Torque Converters,” the user selects the “Torque Converters” descriptor. In the example provided, the user selects the “Torque Convertors” descriptor, and the handheld device 103 display the part list GUI 1200 shown in FIG. 12.

Note that the category information 1100 may be transmitted to the handheld device 103 from the server 102. In this regard, the server 102 queries the part databases 105-n, which returns relevant information about the vehicle including the fitment information that includes all the parts available for the vehicle.

In the example provided, the user selects the “Torque Convertors” descriptor, and the handheld device 103 displays all the torque converters that may be used in the transmission of the vehicle identified in 1102.

In this regard, the handheld device 103 displays the parts list GUI 1200 depicted in FIG. 1200. That is, the handheld device 103 displays “Torque Converter Lock-Up, 13.50,” including a price, e.g., $462.15, and a year, e.g., 2001-2008, “Torque Converter 2000 RPM Stall . . . , including a price, e.g., $1036, and a year, e.g., 2001-2008, and “Torque Converter 2700 RPM Stall . . . ” including a price, e.g., #2,217.38, and a year, e.g., 2001-2008.

Once the user decides which part the user desires to purchase, the selects the box of the torque converter the user desires to purchase.

When the user chooses the part the user desires, the handheld device 103 displays part details in part detail GUI 1300. The part detail GUI 1300 comprises a block 1303 that describes the part selected. The GUI 1300 also comprises a block 1302 describing estimated arrival and number of parts in stock. In block 1301, the GUI 1300 comprises the part details.

From the GUI 1300, the user can select “BUY NOW” button 1303 to purchase the part. Alternatively, the user can select “Add to Cart,” and the app control logic 306 moves the part into the digital cart 1306.

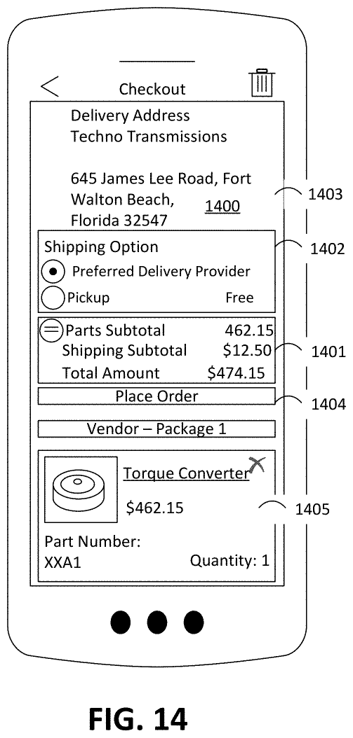

FIG. 14 is the handheld device 103 (FIG. 1) displaying a place order GUI 1900. The place order GUI 1900 comprises a delivery address block 1903 that identifies to where the part is to be shipped. In box 1902 shipping options are displayed, including preferred delivery provider or pickup for free.

Additionally, the place order GUI 1900 comprises a pricing box 1901 that shows the part subtotal ($1.50), the shipping subtotal ($12.50), and the total amount ($14.00). Also, the place order GUI 1900 comprises a part identification box 1905, which shows the part the user of the handheld device 103 is purchasing. When the user of the handheld device 103 is satisfied with the data on the place order GUI 1900, the user selects the “Place Order” box 1904. Upon selection of the “Place Order” box, the system, subsystem, or part is ordered.

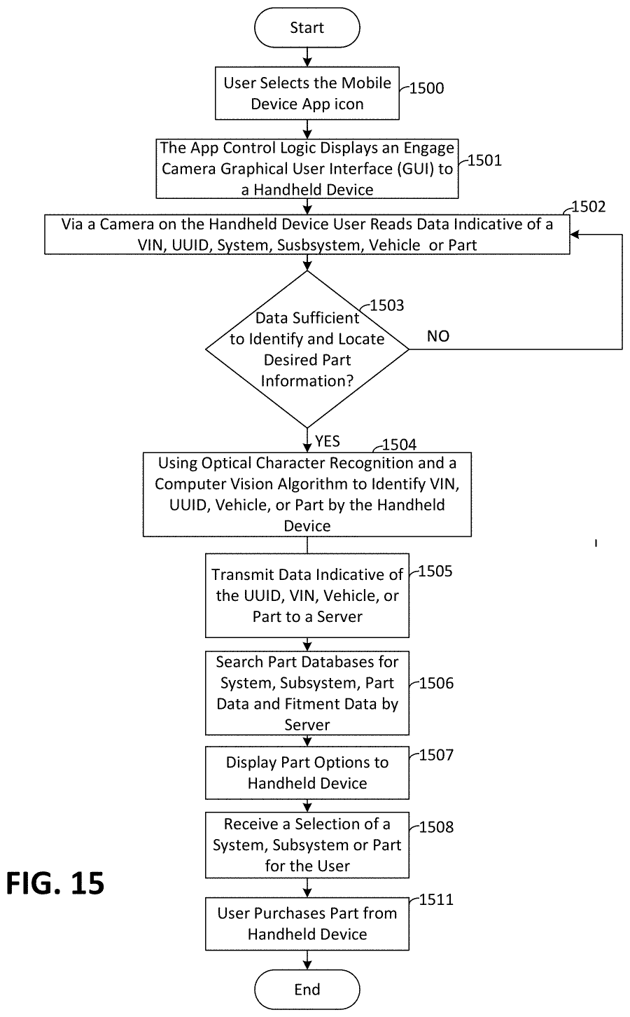

FIG. 15 is a flowchart depicting the architecture and functionality of the part identification and location system 100 (FIG. 1).

In step 1500, the user has a handheld device 103 (FIG. 1), and on the display is a mobile device app icon 401 (FIG. 4). To enter the part identification and location system 100, the user selects the mobile device icon 401. In response, the app control logic 306 (FIG. 3) displays an engage camera user interface (GUI) 500 (FIG. 5A) to the user's display output interface 304 (FIG. 3).

In step 1501, the app control logic 306 displays an engage camera GUI 500 (FIG. 5A) to the output interface 304. The user of the handheld device 103 can elect to read a VIN, a UUID, a part, a vehicle, a system, or a subsystem of a vehicle 104 (FIG. 1).

In step 1502, the user of the handheld device 103 reads, via the camera on the handheld device 103, data indicative of the VIN, UUID, vehicle, system, subsystem, or part. Note that the user of the handheld device 103 may use the handheld device's camera to read data indicative of a VIN, UUID, vehicle, system, subsystem, or part with the camera.

In step 1503, if the data read by the user of the handheld device 103 is insufficient, the app control logic 306 displays the engage camera GUI 500 in step 1502.

In step 1503, if the data read by the user of the handheld device 103 is sufficient for identifying and locating a part, then the app control logic 306 (FIG. 3) on the handheld device 103 (FIG. 1), the app control logic 306 performs optical character recognition and Computer Vision on the data read by the camera, in step 1504

In step 1505, the app control logic 306 transmits data indicative of what the camera read to the server 102. Upon receipt of the information from the control logic 306, the control logic 205 queries a plurality of part databases with the information received from the app control logic 306 in step 1506.

In step 1507, the app control logic 306 displays the one or more parts found in the search to the user of the handheld device 103. In step 1507, the app control logic 306 receives a selection of one of the listed parts from the user of the handheld device 103.

In step 1511, the user purchases the part from the list that the user desires. In this regard, the app control logic 306 obtains delivery address data and payment method, and the user of the handheld device 103 purchases the part via the handheld device 103.

1. A part identification and location system, comprising: a server;
a handheld device, the handheld device communicatively coupled to the server via a network;
a handheld device processor configured for displaying a plurality of graphical user interfaces to the handheld device configured for visually reading, by a camera, the letters, the numbers, the characteristics, or symbols of an image contained in vehicle data through use of computer vision and machine learning the vehicle data comprising at least one of a VIN, UUID, vehicle, vehicle image, system, system image, subsystem, subsystem image, part, or part image and the handheld device processor configured for determining whether the data read identifies a the VIN, the UUID, the vehicle, the vehicle image, the system, the system image, the subsystem, the subsystem image, the part or the part image, by digesting via machine learning the vehicle data on related images and recognizes specific characteristics and patterns the handheld device processor further extracts information from images and pixels of the images read by the handheld device processor, and the handheld device processor identifies a read of interest in the read vehicle data and recognizes the images in a structured format, the handheld device processor further configured to transmit data indicative of the vehicle data read by a camera on the handheld device to a server processor, the server processor configured for automatically searching for the desired VIN, UUID, vehicle, vehicle image, system, system image, subsystem, subsystem image, part or part image on a plurality of part databases, automatically locating one or more parts that match the VIN, UUID, vehicle, vehicle image, system, system image, subsystem, subsystem image, part or part image and receiving fitment data related to a vehicle identified by the handheld device, the handheld device processor further configured for displaying a list of the parts located, receiving data indicating which part the user desires to purchase and receiving payment data for purchasing the part,
wherein the handheld device processor is further configured to read vehicle data when the vehicle is not near the handheld processor.

2. The part identification and location system of claim 1, wherein the vehicle data received from the user of the handheld device is a vehicle identification number (VIN) and the handheld device processor performs optical character recognition (OCR) coupled with Computer Vision on the VIN.

3. The part identification and location system of claim 2, wherein the handheld device processor and/or the server processor is configured for determining a make, model, and year of a vehicle based upon the VIN.

4. The part identification and location system of claim 3, wherein the server processor is configured for searching the plurality of part databases based upon the VIN, wherein the handheld device processor is further configured for displaying a list of parts found from the searching by the server processor, and the handheld device processor is configured for selling the part to the user via the handheld device.

5. The part identification and location system of claim 1, wherein the vehicle data received from the user of the handheld device is a universally unique identifier (UUID) and the handheld processor performs optical character recognition (OCR) coupled with Computer Vision on the UUID.

6. The part identification and location system of claim 5 wherein the handheld device processor and/or the server processor is configured for determining a make, model and year of a vehicle based upon the UUID.

7. The part identification and location system of claim 6, wherein the server processor is configured for searching the plurality of part databases based upon the UUID.

8. The part identification and location system of claim 7, wherein the handheld device processor is further configured for displaying a list of parts found from the searching by the server processor.

9. The part identification and location system of claim 8, wherein the handheld device processor is further configured for receiving vehicle data indicating a part read by the handheld device.

10. The part identification and location system of claim 9, wherein the handheld device processor is configured for selling the part to the user via the handheld device.

11. (canceled)

12. The part identification and location system of claim 11, wherein the handheld processor and the server processor are configured for determining a make, a model, and a year of a vehicle or identifying a part or type of part based upon the read by performing Computer Vision with optical character recognition (OCR) and aided by Artificial Intelligence on the data read by the camera on the handheld device.

13. The part identification and location system of claim 12, wherein the server processor is configured for searching the plurality of part databases based upon the read.

14. The part identification and location system of claim 13, wherein the handheld device processor is further configured for displaying a list of parts found from the searching by the server processor.

15. The part identification and location system of claim 14, wherein the handheld device processor is further configured for receiving data indicating a part read by the handheld device.

16. The part identification and location system of claim 15, wherein the handheld device processor is configured for selling the part to the user via the handheld device.

17. A part identification and location method, comprising: communicatively coupling a handheld device to a server via a network;
displaying, by a handheld device processor, a plurality of graphical user interfaces to
the handheld device configured for visually reading the letters, the numbers, or symbols of an image contained in the vehicle data through use of computer vision, the vehicle data comprising at least one of a vehicle identification number (VIN), universally unique identifier (UUID), vehicle, vehicle image, system, system image, subsystem, subsystem image part, or part image;
determining, by the handheld processor, whether the vehicle data read identifies a VIN, UUID, vehicle, vehicle image, system, system image, subsystem, subsystem image, part, or part image by digesting via learning or machine learning vehicle data on related images and recognizing specific characteristics and patters, the images read by the handheld device and the handheld device processor identifies a read area of interest in the read vehicle data and converts images into a structure format;
transmitting data indicative of the read by a camera on the handheld device to a server processor;
automatically searching, by the server processor, for the desired VIN, UUID, vehicle, vehicle
image, system, system image, subsystem, subsystem image, part or part image on a plurality of part databases;
automatically locating, by the server processor, one or more parts that match the VIN, UUID,
vehicle, vehicle image, system, system image, subsystem, subsystem image, part or part image.
receiving fitment data related to a vehicle identified by the handheld device;
displaying, by the handheld device processor, a list of the VIN, UUID, system, vehicle, vehicle image, system, system image, subsystem, subsystem image, part, or part image located;
receiving data, by the handheld device processor, indicating which part the user desires to purchase; and
receiving payment, by the handheld device processor, data for purchasing the system, subsystem, or part.

18. The part identification and location method of claim 17, wherein the vehicle data received from the user of the handheld device is a vehicle identification number (VIN) further comprising performing, by the handheld device and/or the server, optical character recognition (OCR) and Computer Vision on the VIN.

19. The part identification and location method of claim 18, further
comprising determining, by the handheld device and/or the server, a make, model, and year of a vehicle based upon the VIN.

20. The part identification and location method of claim 19, further comprising searching, by the server processor, the plurality of part databases based upon the VIN.

21. The part identification and location method of claim 20, further comprising displaying, by the handheld device, a list of parts found from the searching by the server processor, and receiving, by the handheld device processor, a read of data indicating a VIN, UUID, system, subsystem, or part from the user of the handheld device via the handheld device, and digitally selling, by the handheld device processor the part to the user via the handheld device.

22. The part identification and location method of claim 17, wherein the vehicle data received from the user of the handheld device is a universally unique identifier (UUID) further comprising performing, by the handheld processor and/or the server, optical character recognition (OCR) and Computer Vision on the UUID.

23. The part identification and location method of claim 22, further comprising determining, by the handheld processor and/or the server processor, a make, model, and year of a vehicle based upon the UUID.

24. The part identification and location method of claim 23, further comprising searching, by the server processor, the plurality of part databases based upon the UUID.

25. The part identification and location method of claim 24, further comprising displaying, by the handheld processor, a list parts found from the searching by the server processor.

26. The part identification and location method of claim 25, further comprising receiving, by the handheld processor, data indicating a VIN, UUID, system, subsystem, or part from a user of the handheld device via the handheld device.

27. The part identification and location method of claim 26, further comprising digitally selling, by the handheld processor, the part to the user via the handheld device.

28. The part identification and location method of claim 17, wherein the vehicle data received from the user of the handheld device is an image of a VW, UUID, system, subsystem, or part further comprising determining, by the handheld processor and/or the server processor, a make, model, and year of a vehicle based upon the image by performing optical character recognition (OCR) and Computer Vision on the image.

29. The part identification and location method of claim 28, further comprising searching, by the server processor, the plurality of part databases based upon the image obtained from the OCR and the Computer Vision, and displaying, by the handheld processor, a list of parts found from the searching by the server processor.

30. The part identification and location method of claim 26, further comprising receiving data, by the handheld device processor, indicating a VIN, UUID, system, subsystem, or a part from the user of the handheld device via a camera on the handheld device and digitally selling, by the handheld device processor, the part to the user via the handheld device.
